(19) United States
(12) Patent Application Publication
(10) Pub. No.: US 2010/0097635 A1
(43) Pub. Date: Apr. 22, 2010

(54) Printer upgrade mechanism

(75) Inventors: Marquis Waller, Beverly, OH (US); Elke Jones, Llano, TX (US); Stephen Goddard Price, Longmont, CO (US); Diane McKee, Longmont, CO (US); J. Douglas Henley, Mead, CO (US)

Correspondence Address: InfoPrint Solutions/ Blakely, 1279 Oakmead Parkway, Sunnyvale, CA, 94085-4040, US

(73) Assignee: InfoPrint Solutions Company LLC

(21) Appl. No.: 12/288,290

(22) Filed: Oct. 17, 2008

(51) Int. Cl. G06F 3/12

(52) U.S. Cl. 358/1.15

(57) ABSTRACT

A method for providing computer services is disclosed. The method includes a print server receiving a data file including updates for a printer, parsing the file to acquire one or more update options and defaults for the printer and storing the update options and defaults for the printer in a database.

### FIELD OF THE INVENTION

The invention relates to the field of computer systems, and in particular, to upgrading printing software products.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from order entry and management through the complete printing process. Periodically, printing software products need to be upgraded to add support for new printer models, set new defaults (e.g., halftones, data streams) and add new options (media sizes, input trays) that vary with each printer model. However, current printing software products require installation upgrades, such as program Temporary fixes (PTF's), which require re-installing the printing software. Constant software updates result in a waste of time and money. Also, since a software vendor cannot ship settings for every printer model a customer may have, support for many printer models in the software package may be limited. Customers are unhappy with having to install upgrades to support new printer models, and even unhappier that some models are not supported at all.

Accordingly, a mechanism to efficiently upgrade printing software is desired.

### SUMMARY

In one embodiment, a method for providing computer services. The method includes a print server receiving a data file including updates for a printer, parsing the file to acquire one or more update options and defaults for the printer and storing the update options and defaults for the printer in a database.

Another embodiment discloses a print server including an update services module to import a data file including updates for a printer and to parse the file to acquire one or more update options and defaults for the printer and a database to store the update options and defaults.

A further embodiment discloses an article of manufacture comprising a machine-readable medium including data that, when accessed by a machine, cause the machine to perform operations comprising a print server receiving a data file including updates for a printer, parsing the file to acquire one or more update options and defaults for the printer and storing the update options and defaults for the printer in a database.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a flow diagram illustrating one embodiment for upgrading printing software;

FIG. 3 is a flow diagram illustrating another embodiment for upgrading printing software; and

FIG. 4 illustrates one embodiment of a computer system.

### DETAILED DESCRIPTION

A printing software upgrade mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

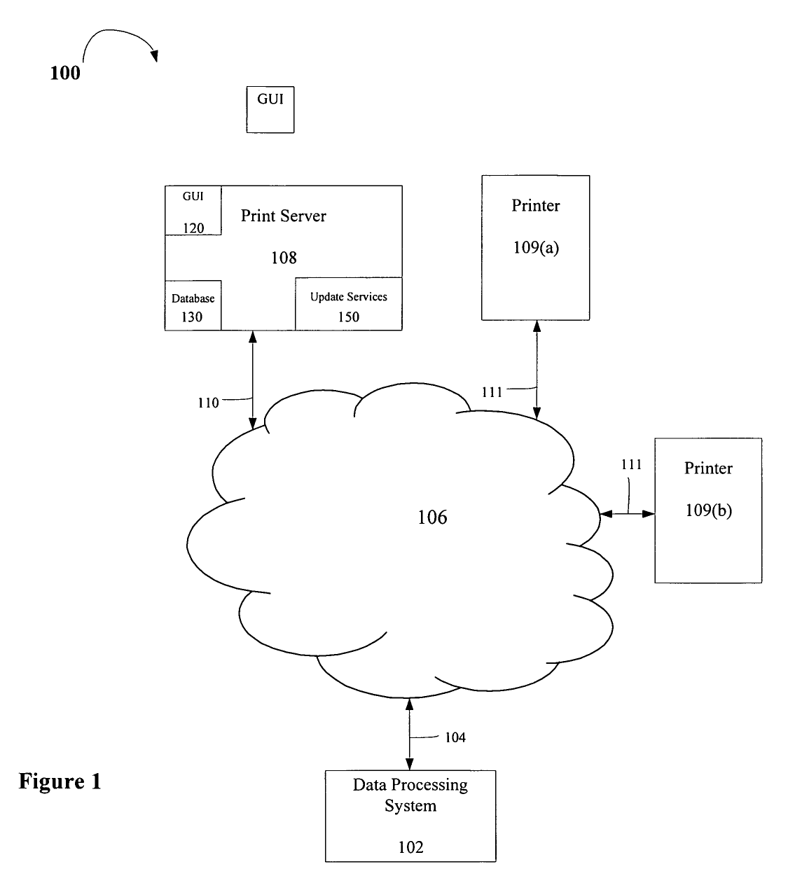

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, the operating system on data processing system 102 allows a user to select the desired print server 108 and submit requests for service requests to printer 109 via print server 108 over network 106. In a further embodiment, print server 108 includes a print queue for print jobs requested by remote data processing systems.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and one or more of printers 109. In other embodiments, the printing software manages printing of documents from multiple data processing systems 102 to the one or more printers 109.

According to one embodiment, the printing software product may be implemented using either InfoPrint Manager (IPM) or Infoprint ProcessDirector (IPPD), although other types of printing software may be used instead. In one embodiment, the printing software product includes a graphical user interface (GUI) 120, a database 130 and an update service module 150.

GUI 120 enables a system administrator (or operator) to interact with the printing software product. Database 130 is a structured collection of stored records and/or data. According to one embodiment, objects and values associated with the printing software are stored at database 130. Exemplary objects include MediaSizes, MediaType, Input Trays, Output Bins, Printer Models, Jobs, Drop down choice (e.g., options for different attributes), etc.

Update service module 150 is a component that enables the efficient upgrading of the printing software. According to one embodiment, update service module 150 facilitates the addition of new printer models to be added by importing a data file that includes the printer's defaults and options. In an additional embodiment, the file is an Extensible Markup Language (XML) file that may be imported from a server (e.g., web server) operated by the vendor of the new printer or imported from a web server running within the new printer. In such an embodiment, an operator initiates the download of the XML file to update service module 150.

In another embodiment, an XML file can be generated to provide customized options (e.g., custom halftones or custom media sizes) that may be added to existing selections. In this embodiment, the operator implements GUI 120 to create the XML of customized options and to download the XML file to update service module 150. After import to update service module 150, the new printer models and customized print options may be selected at GUI 120 and used in the software product.

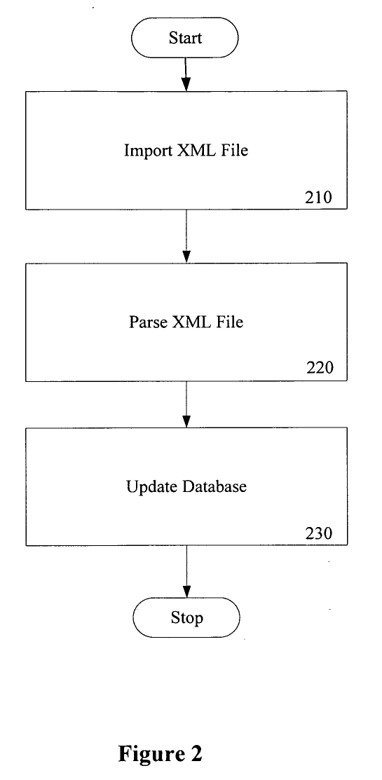

FIG. 2 is a flow diagram illustrating one embodiment for upgrading printing software. At processing block 210, update services module 150 imports an XML file to print server 108. At processing block 220, print server 108 parses the XML file to acquire the print options. In one embodiment, the XML file includes key words that indicate to the printing software operating on print server 108 as to the type of objects that are to be updated and which values to set.

At processing block 230, database 130 is updated with the new objects and values. In a further embodiment, the XML file may also be used to indicate the removal of objects or values from the database. Upon subsequent queries of database 130, GUI 120 will find the new objects and values and use them to populate its tables and drop downs. Once the update is complete, a user is capable of observing the changes without restarting the printing software.

According to one embodiment, printer 109 includes one or more XML settings files that are installed on printer 109 upon initial configuration. Further, GUI 120 may include a button to import printer settings, where selection of the button by a user downloads the file from printer 109. In one embodiment, the file is downloaded via a file transport protocol (FTP). However in other embodiments, the file may be downloaded using other file transfer mechanisms (e.g., the World Wide Web via Hypertext Transfer Protocol (HTTP), Intelligent Printer Data Stream (IPDS), etc.).

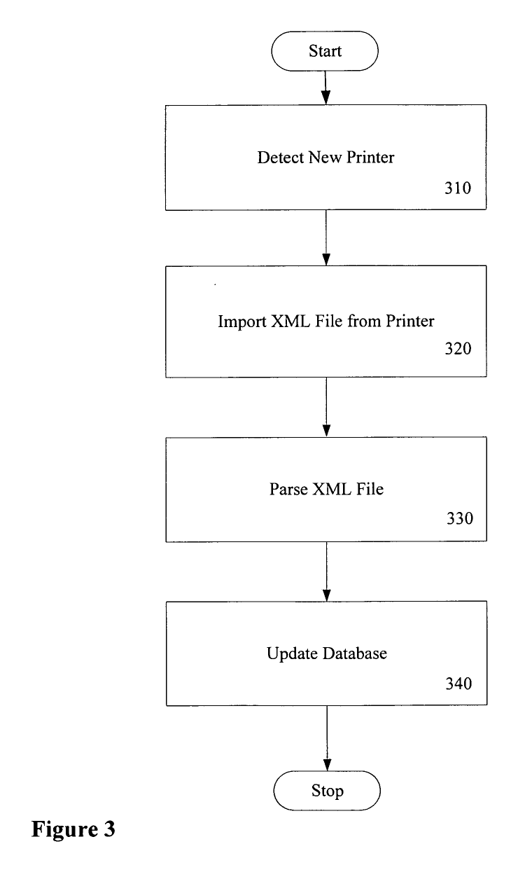

According to one embodiment, the delivery and installation of the upgrade file may occur automatically, dispensing with the requirement of an operator selecting the install button. FIG. 3 is a flow diagram illustrating one embodiment for automatically upgrading printing software. At processing block 310, print server 108 detects a new printer 109 coupled to network 106. In one embodiment, print server 108 detects a new printer 109 via Simple Network Management Protocol (SNMP). However in other embodiments print server 108 may detect a new printer 109 via other mechanisms, such as Internet Printing Protocol (IPP), or having the new printer 109 selected as a destination for installation or printing.

Upon detecting the new printer 109, update services module 150 automatically imports the file from printer 109 via network 106, processing block 320. At processing block 330, print server 108 parses the XML file to obtain the print options. At processing block 340, database 130 is updated with the new objects and values.

According to one embodiment, each printer 109 includes variable configurations (e.g., optional input trays and finishers) that provide a file that is customized to the printer 109 configuration. In a further embodiment, each printer 109 would track each print server 108 that has requested the file be downloaded. Therefore, when the printer configuration changes in a manner that would change the data that would be reported (e.g. a new optional input tray was installed), printer 109 subsequently notifies all print servers 108 that received the obsolete data. At this point, the print server 108 automatically requests an updated file.

In another embodiment, print server 108 may provide an operator a prompt requesting authorization to download the file. In such an embodiment, the file is downloaded if the operator provides the authorization. In still another embodiment, printer 109 transmits the file via a print job submission method (e.g., as hot folder or Line Printer Remote (LPR) protocols).

Subsequently, print server 108 automatically imports the file, or supplies a prompt to the operator at data processing system 102. The prompt may include options as to whether the file is to be downloaded “now”, “later”, or “never”. If the operator selects “never”, the file is deleted. If “later”, the file is saved and either a notification is posted of a pending update, or there is a menu that lists all pending update(s).

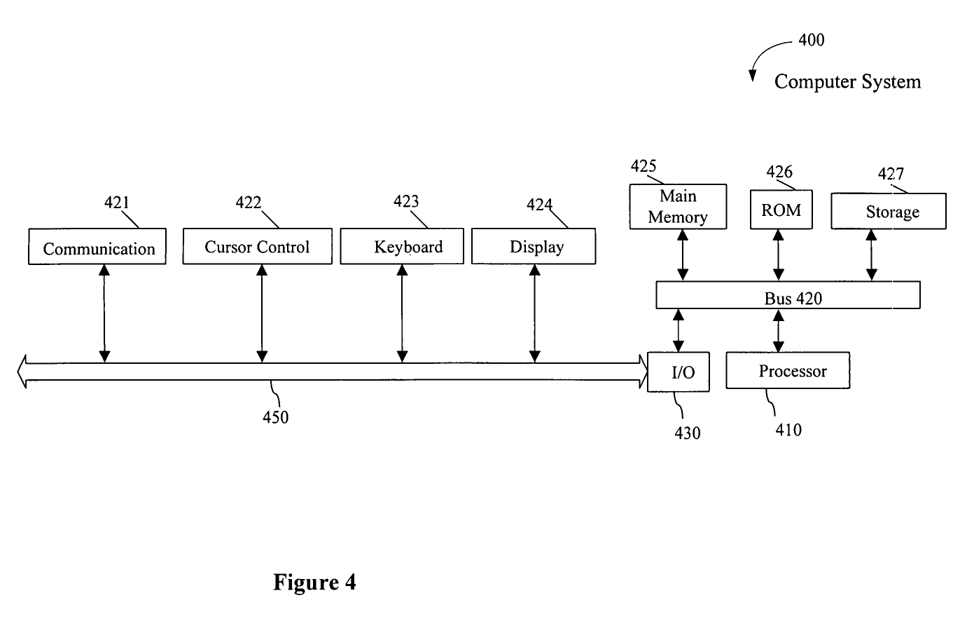

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients) via external data network 170. The communication device 421 may comprise a modem, a network interface card, or other well-known interface device, such as those used for coupling to Ethernet, token ring, or other types of networks.

The above-described mechanism enables a system user to import only the printer models and customized options the user is interested in without the risk of installing a new version of the product, or cluttering their GUI selections with a lot of options they never use. Thus, time and expense are saved by only generating and installing one file to support a new printer model.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method for providing computer services, comprising:
a print server receiving a data file including updates for a printer;
parsing the file to acquire one or more update options and defaults for the printer; and
storing the update options and defaults for the printer in a database.

2. The method of claim 1 further comprising accessing the database to retrieve the update options and defaults to interface with the printer.

3. The method of claim 1 wherein the data file is received from a web server upon an operator initiating a download of the data file to the print server.

4. The method of claim 1 wherein the data file is received from the printer upon an operator initiating a download of the data file to the print server.

5. The method of claim 4 wherein the data file is automatically received from the printer.

6. The method of claim 5 wherein automatically receiving the data file comprises:
automatically detecting a configuration change at the printer; and
receiving the file data file from the printer.

7. The method of claim 1 wherein the data file is an Extensible Markup Language (XML).

8. A print server, comprising:
an update services module to import a data file including updates for a printer and to parse the file to acquire one or more update options and defaults for the printer; and
a database to store the update options and defaults.

9. The print server of claim 8 wherein the data file is an Extensible Markup Language (XML) file.

10. The print server of claim 9 further comprising a graphical user interface (GUI) to access the database to retrieve the update options and defaults to interface with the printer.

11. The print server of claim 10 wherein the GUI includes a button to enable an operator to initiate the import of the XML file.

12. The print server of claim 11 wherein the XML file is imported from a web server.

13. The print server of claim 11 wherein the XML file is imported from the printer.

14. The print server of claim 9 wherein the data file is automatically imported by the update services module upon detecting a new printer.

15. The print server of claim 9 wherein the data file is automatically imported by the update services module upon detecting a configuration change at the printer.

16. An article of manufacture comprising a machine-readable medium including data that, when accessed by a machine, cause the machine to perform operations comprising:
a print server receiving a data file including updates for a printer;
parsing the file to acquire one or more update options and defaults for the printer; and
storing the update options and defaults for the printer in a database.

17. The article of manufacture of claim 16, wherein the machine-accessible medium include data that cause the machine to perform further operations comprising accessing the database to retrieve the update options and defaults to interface with the printer

18. The article of manufacture of claim 16 wherein the data file is received from a web server upon an operator initiating a download of the data file to the print server.

19. The article of manufacture of claim 16 wherein the data file is an Extensible Markup Language (XML).

20. The article of manufacture of claim 16, wherein the machine-accessible medium include data that causes the machine to perform further operations comprising automatically receiving the data file by:
automatically detecting a configuration change at the printer; and
receiving the file data file from the printer.
